(19) United States
(12) Patent Application Publication
(10) Pub. No.: US 2026/0331548 A1
(43) Pub. Date: Oct. 22, 2026

(54) SYSTEMS AND METHODS FOR SCALING UP OF MICROTUBULAR FLOW BATTERIES

(71) Applicant: Georgia Tech Research Corporation, Atlanta, GA (US)

(72) Inventors: Nian Liu, Atlanta, GA (US); Ryan P. Lively, Atlanta, GA (US); Xing Xie, Atlanta, GA (US)

(21) Appl. No.: 19/122,906

(22) PCT Filed: Nov. 6, 2023
(86) PCT No.: PCT/US2023/078803

§ 371 Date: Apr. 21, 2025

Related U.S. Application Data
(60) Provisional application No. 63/382,329, filed on Nov. 4, 2022.

(51) Int. Cl. H01M 8/18

(52) U.S. Cl. CPC H01M 8/188

(57) ABSTRACT

An exemplary embodiment of the present disclosure provides a microtubular flow battery, comprising a plurality of tube-shaped ion exchange membranes, one or more first electrodes, one or more second electrodes, a first electrolytic fluid, and a second electrolytic fluid. The plurality of tube-shaped ion exchange membranes can define an inner lumen. The one or more first electrodes can be disposed within the inner lumen of each of the membranes. The one or more second electrodes can be disposed among the plurality of tube-shaped membranes outside of the inner lumens of the tube-shaped membranes. The first electrolytic fluid can be positioned within the inner lumens of the plurality of membranes. The second electrolytic fluid can be positioned outside of the inner lumens of the plurality of membranes.

### CROSS-REFERENCE TO RELATED APPLICATIONS

This application claims the benefit of U.S. Provisional Application Ser. No. 63/382,329, filed on 4 Nov. 2022, which is incorporated herein by reference in its entirety as if fully set forth below.

### FIELD OF THE DISCLOSURE

The various embodiments of the present disclosure relate generally to batteries, and more particular to microtubular flow batteries.

### BACKGROUND

Flow batteries are a promising technology for large scale and long-duration energy storage. These systems exhibit unparalleled advantages in scalability, design flexibility and lifespan, owing to the spatially decoupled energy storage unit and power conversion unit. While significant progress has been made on flow battery materials and electrochemistry to improve energy density, conventional flow battery systems based on planar cell configurations exhibit limited membrane surface area in a given volume, ultimately resulting in low volumetric power density. Also, the 2D flow channels and plates places challenges to manufacturing, leading to the high capital cost. Accordingly, there is a need for improved flow batteries and their manufacturing processes

### BRIEF SUMMARY

An exemplary embodiment of the present disclosure provides a microtubular flow battery, comprising a plurality of tube-shaped ion exchange membranes, one or more first electrodes, one or more second electrodes, a first electrolytic fluid, and a second electrolytic fluid. The plurality of tube-shaped ion exchange membranes can define an inner lumen. The one or more first electrodes can be disposed within the inner lumen of each of the membranes. The one or more second electrodes can be disposed among the plurality of tube-shaped membranes outside of the inner lumens of the tube-shaped membranes. The first electrolytic fluid can be positioned within the inner lumens of the plurality of membranes. The second electrolytic fluid can be positioned outside of the inner lumens of the plurality of membranes.

In any of the embodiments disclosed herein, the one or more first electrodes can comprise a plurality of carbon fibers.

In any of the embodiments disclosed herein, the battery can be capable of providing a peak charge power density of at least 50 W/Lcell, 100 W/Lcell, 150 W/Lcell, 200 W/Lcell, 250 W/Lcell, 300 W/Lcell, 350 W/Lcell, 400 W/Lcell, 450 W/Lcell, 500 W/Lcell, 550 W/Lcell, 600 W/Lcell, 650 W/Lcell, 700 W/Lcell, 750 W/Lcell, 800 W/Lcell, or 814 W/Lcell.

In any of the embodiments disclosed herein, the battery can be capable of providing a peak charge power density of 814 W/Lcell.

In any of the embodiments disclosed herein, the battery can be capable of providing a peak discharge power density of at least 30 W/Lcell, 50 W/Lcell, 75 W/Lcell, 100 W/Lcell, 125 W/Lcell, 150 W/Lcell, 175 W/Lcell, 200 W/Lcell, or 220 W/Lcell.

In any of the embodiments disclosed herein, the battery can be capable of providing a peak discharge power density of 220 W/Lcell.

In any of the embodiments disclosed herein, the one or more first electrodes can have a surface-area-to-volume ratio that is within 50% of a surface-area-to-volume ratio of the membranes, within 40% of a surface-area-to-volume ratio of the membranes, within 30% of a surface-area-to-volume ratio of the membranes, within 20% of a surface-area-to-volume ratio of the membranes, within 15% of a surface-area-to-volume ratio of the membranes, within 10% of a surface-area-to-volume ratio of the membranes, within 5% of a surface-area-to-volume ratio of the membranes, or within 1% of a surface-area-to-volume ratio of the membranes.

In any of the embodiments disclosed herein, the one or more first electrodes can have a surface-area-to-volume ratio that is within 5% of a surface-area-to-volume ratio of the membranes.

In any of the embodiments disclosed herein, the first electrolytic fluid can be in contact with the one or more first electrodes.

In any of the embodiments disclosed herein, the second electrolytic fluid can be in contact with the one or more second electrodes.

In any of the embodiments disclosed herein, the one or more first electrodes can serve as cathodes of the battery, and the one or more second electrodes can serve as anodes of the battery.

In any of the embodiments disclosed herein, the battery can further comprise a chamber having an outer wall, and at least a portion of each of the plurality of ion exchange membranes, at least a portion of each of the first electrodes, and at least a portion of each of the one or more second electrodes can be positioned within the chamber.

In any of the embodiments disclosed herein, each of the plurality of ion exchange membranes can comprise a first and a second end, and each of the first ends and the second ends extending through the outer wall of the chamber.

In any of the embodiments disclosed herein, each of the first ends of the plurality of ion exchange members can comprise an inlet configured to receive the first electrolytic fluid into the respective inner lumen, and each of the second ends of the plurality of ion exchange members can comprise an outlet configured to eject the first electrolytic fluid out of the respective inner lumen.

In any of the embodiments disclosed herein, each of the inlets of the plurality of ion exchange membranes can be in fluid communication with a first electrolytic fluid supply source.

In any of the embodiments disclosed herein, the chamber can comprise an inlet for receiving the second electrolytic fluid into the chamber and an outlet for ejecting the second electrolytic fluid out of the chamber.

In any of the embodiments disclosed herein, each of the one or more first electrodes can be in electrical communication with each other.

In any of the embodiments disclosed herein, each of one or more second electrodes can be in electrical communication with each other.

Another embodiment of the present disclosure provides a method of manufacturing a microtubular flow battery, comprising: coating a fiber electrode with at least a first polymer; coating the polymer coated fiber with an ion exchange membrane; and removing at least a portion of the first polymer from the ion exchange membrane coated fiber to form a tubular membrane coated fiber.

In any of the embodiments disclosed herein, the method can further comprise spinning the fiber electrode from a spool.

In any of the embodiments disclosed herein, the fiber electrode can be carbon fiber.

In any of the embodiments disclosed herein, the first polymer can be a water-soluble polymer.

In any of the embodiments disclosed herein, the first polymer can be in a molten state.

In any of the embodiments disclosed herein, the first polymer can be in a solution.

In any of the embodiments disclosed herein, the first polymer can comprise poly-vinyl alcohol (PVA).

In any of the embodiments disclosed herein, the ion exchange membrane can comprise a sulfonated tetrafluoroethylene-based fluoropolymer-copolymer.

In any of the embodiments disclosed herein, the sulfonated tetrafluoroethylene based fluoropolymer-copolymer can be Nafion®.

In any of the embodiments disclosed herein, the ion exchange membrane can be in a solution.

In any of the embodiments disclosed herein, the first polymer can be water soluble, and removing at least a portion of the first polymer from the ion exchange membrane coated fiber can comprise exposing the ion exchange membrane coated fibers to water to dissolve the first polymer.

In any of the embodiments disclosed herein, removing at least a portion of the first polymer from the ion exchange membrane coated fiber can create an interstitial space in a lumen of the tubular membrane coated fiber.

In any of the embodiments disclosed herein, the method can further comprise spinning the tubular membrane coated fiber onto a spool.

In any of the embodiments disclosed herein, coating the fiber electrode with at least a first polymer can comprise applying a dual layer coating to the fiber electrode, and the dual layer coating can comprise an inner porous support layer and an outer ion-selective layer.

In any of the embodiments disclosed herein, applying the dual layer coating to the fiber can comprise coextruding, using a triple orifice spinneret, the fiber electrode, the inner porous support layer, and the outer ion-selective layer.

In any of the embodiments disclosed herein, the method can further comprise quenching the polymer coated fiber in a water bath to phase invert the outer ion-selective layer.

In any of the embodiments disclosed herein, coating the polymer coated fiber with an ion exchange membrane can comprise coating the outer ion-selective layer with the ion exchange membrane.

In any of the embodiments disclosed herein, removing the at least a portion of the first polymer from the ion exchange membrane coated fiber can comprise removing at least a portion of the inner porous support layer.

In any of the embodiments disclosed herein, the inner porous support layer can comprise glycol.

In any of the embodiments disclosed herein, the outer ion-selective layer can comprise polyvinylidene fluoride (PVDF).

In any of the embodiments disclosed herein, the method can be a roll-to-roll manufacturing method.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a schematic of a microtubular flow battery, in accordance with some embodiments of the present disclosure.

FIG. 2A illustrates operating principle of a CAMT flow cell, FIG. 2B provides a SEM image of the cross section of a CAMT cell, FIG. 2C provides COMSOL model comparing a conventional planar cell (left) and a tubular CAMT cell (right) with the same volume, FIG. 2D provides a plot of simulated current density of a planar cell and a microtubular cell at a series of current densities, and FIG. 2E provides a plot of cycling performance of all-vanadium CAMT flow battery, all in accordance with some embodiments of the present disclosure.

FIG. 3A provides a 3D rendering of a 5 Wh module, and FIG. 3B provides a schematic of the sealing, electrical connection, and electrolyte flow pathways, in accordance with some embodiments of the present disclosure.

FIG. 4 provides a continuous process to directly mass-produce 1D electrode-electrolyte assembly, in accordance with some embodiments of the present disclosure.

FIG. 5A provides a 3D rendering of a 250 Wh module, and FIG. 5B provides a picture of a poly(vinylidene fluoride) (PVDF) hollow fiber membrane module with ~1,300 hollow fibers inside (the size of the Swagelok is 1 inch, in accordance with some embodiments of the present disclosure.

FIGS. 6A-C provide SEM images of a PVDF hollow fiber coated with a ~100 nm thick Teflon AF2400 membrane layer, in accordance with some embodiments of the present disclosure.

FIGS. 7A-B provide schematic of the direct and continuous manufacturing of dual layer microtubular membrane with carbon fiber in the middle, in accordance with some embodiments of the present disclosure. FIG. 7A provides a triple orifice spinneret, in accordance with some embodiments of the present disclosure. FIG. 7B provides a carbon fiber can be fed through in the middle and co-extruded along with an interstitial glycol solution and an external PVDF solution, in which these fibers can then be transferred to the roll-to-roll coating system for Nafion coating as shown in FIG. 4, in accordance with some embodiments of the present disclosure.

FIG. 8A provides a 3D rendering of the final electrode stack comprising 48 (=6×8) modules (see FIG. 6), and FIG. 8B provides a schematic of the 12 kWh vanadium CAMT flow battery system, in accordance with some embodiments of the present disclosure.

FIG. 9 provides a flow chart of a method of manufacturing a microtubular flow battery, in accordance with some embodiments of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

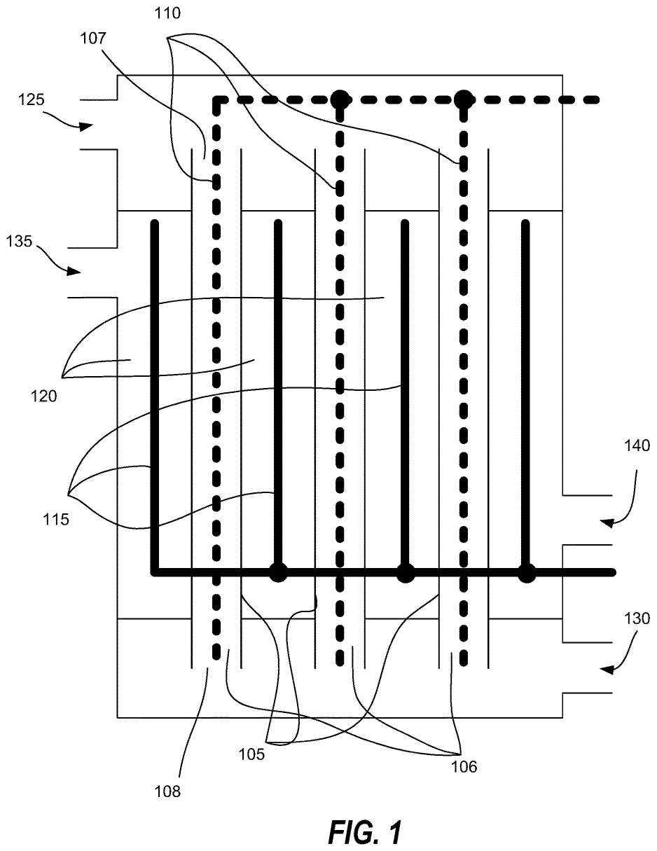

As shown in FIG. 1, an exemplary embodiment of the present disclosure provides a microtubular flow battery. The battery can comprise a plurality of tube-shaped ion exchange membranes 105, one or more first electrodes 110, one or more second electrodes 115, a first electrolytic fluid (not shown), and a second electrolytic fluid (not shown). The plurality of tube-shaped ion exchange membranes 105 can define an inner lumen 106. The one or more first electrodes 110 can be disposed within the inner lumen 106 of each of the membranes 105. The one or more second electrodes 115 can be disposed among the plurality of tube-shaped membranes 105 outside of the inner lumens 106 of the tube-shaped membranes 105. The first electrolytic fluid can be positioned within the inner lumens 106 of the plurality of membranes 105. The second electrolytic fluid can be positioned outside of the inner lumens 106 of the plurality of membranes 105.

The one or more first electrodes can be made of many different electrode materials known in the art, including, but not limited to, metals, alloys thereof, carbon fiber, and the like. In any of the embodiments disclosed herein, the one or more first electrodes 110 can comprise a plurality of carbon fibers. For example, in some embodiments, each first electrode can comprise one or more carbon fibers. The one or more first electrodes 110 can serve as cathodes of the battery.

The one or more second electrodes 115 can be made of many different electrode materials known in the art, including, but not limited to, metals, alloys thereof, carbon fiber, and the like. In any of the embodiments disclosed herein, the one or more second electrodes 115 can comprise a plurality of carbon fibers. For example, in some embodiments, each second electrode can comprise one or more carbon fibers. The one or more second electrodes 115 can serve as cathodes of the battery.

In any of the embodiments disclosed herein, the battery can further comprise a chamber 120 having an outer wall. As shown in FIG. 1, at least a portion of each of the plurality of ion exchange membranes 105, at least a portion of each of the first electrodes 110, and at least a portion of each of the one or more second electrodes 115 can be positioned within the chamber 120. As also shown in FIG. 1, each of the plurality of ion exchange membranes 105 can comprise a first and a second end, and each of the first ends and the second ends extending through the outer wall of the chamber. The second electrolytic fluid can be contained within the chamber 120 flowing through the chamber and contacting the outer surface of the ion exchange membranes 105 and the second electrodes 115. The chamber 120 can comprise an inlet 135 for receiving the second electrolytic fluid into the chamber 120 and an outlet 140 for ejecting the second electrolytic fluid out of the chamber 120.

Each of the first ends of the plurality of ion exchange members 105 can comprise an inlet 107 configured to receive the first electrolytic fluid into the respective inner lumen 106, and each of the second ends of the plurality of ion exchange members can comprise an outlet 108 configured to eject the first electrolytic fluid out of the respective inner lumen 106. As shown in FIG. 1, each of the inlets 107 of the plurality of ion exchange membranes 105 can be in fluid communication with a first electrolytic fluid supply source received through a inlet 125. Thus, the first electrolytic fluid can flow in through the global inlet 125, into the inlets 107 of the ion exchange membranes 105, through the length of the lumen 106 of the ion exchange membranes 105 while contacting the inner walls of the ion exchange membranes and first electrodes 110, out of the outlets 108 of the ion exchange membranes, and out of a global outlet 130. Similarly, the second electrolytic fluid can enter the chamber 120 through an inlet 135, through the chamber 120 contacting the second electrodes 115 and the outer walls of the ion exchange membranes 105, and out of the outlet 140 of the chamber.

As shown in FIG. 1, each of the one or more first electrodes 110 can be in electrical communication with each other (dots shown connection points), and each of one or more second electrodes can be in electrical communication with each other (dots shown connection points).

In any of the embodiments disclosed herein, the battery can be capable of providing a peak charge power density of at least 50 W/Lcell, 100 W/Lcell, 150 W/Lcell, 200 W/Lcell, 250 W/Lcell, 300 W/Lcell, 350 W/Lcell, 400 W/Lcell, 450 W/Lcell, 500 W/Lcell, 550 W/Lcell, 600 W/Lcell, 650 W/Lcell, 700 W/Lcell, 750 W/Lcell, 800 W/Lcell, or 814 W/Lcell. In any of the embodiments disclosed herein, the battery can be capable of providing a peak charge power density of 814 W/Lcell.

In any of the embodiments disclosed herein, the battery can be capable of providing a peak discharge power density of at least 30 W/Lcell, 50 W/Lcell, 75 W/Lcell, 100 W/Lcell, 125 W/Lcell, 150 W/Lcell, 175 W/Lcell, 200 W/Lcell, or 220 W/Lcell. In any of the embodiments disclosed herein, the battery can be capable of providing a peak discharge power density of 220 W/Lcell.

In any of the embodiments disclosed herein, the one or more first electrodes can have a surface-area-to-volume ratio that is within 50% of a surface-area-to-volume ratio of the membranes, within 40% of a surface-area-to-volume ratio of the membranes, within 30% of a surface-area-to-volume ratio of the membranes, within 20% of a surface-area-to-volume ratio of the membranes, within 15% of a surface-area-to-volume ratio of the membranes, within 10% of a surface-area-to-volume ratio of the membranes, within 5% of a surface-area-to-volume ratio of the membranes, or within 1% of a surface-area-to-volume ratio of the membranes. In any of the embodiments disclosed herein, the one or more first electrodes can have a surface-area-to-volume ratio that is within 5% of a surface-area-to-volume ratio of the membranes.

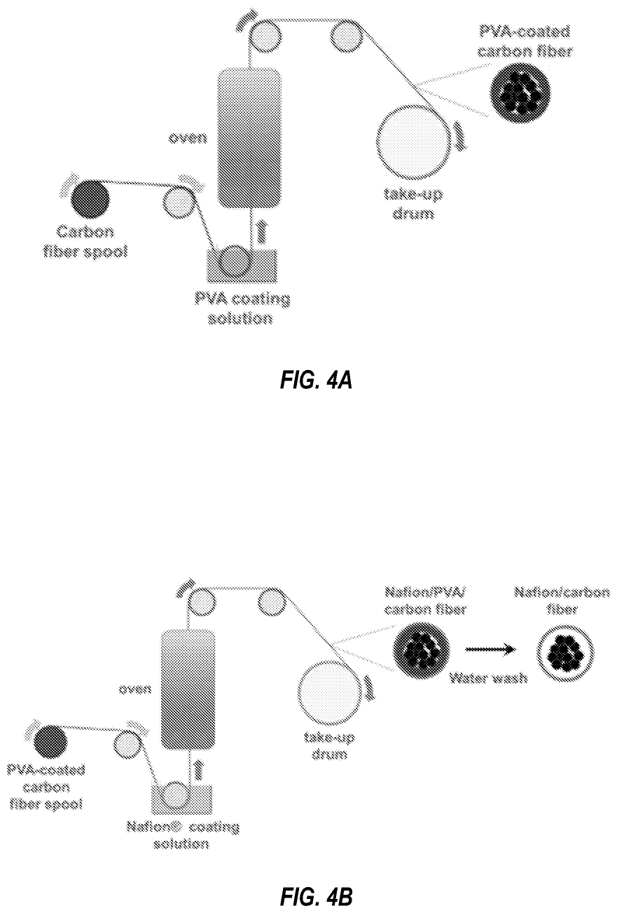

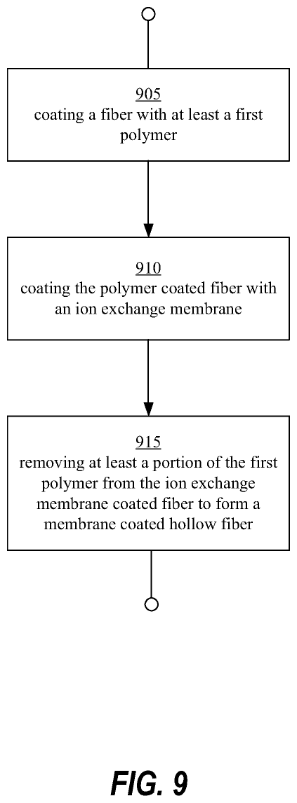

In addition to microtubular flow batteries, embodiments of the present disclosure provide methods of manufacturing microtubular flow batteries. As shown in FIG. 9, an exemplary embodiment of the present disclosure provides a method of manufacturing a microtubular flow battery, comprising: coating a fiber electrode with at least a first polymer 905; coating the polymer coated fiber with an ion exchange membrane 910; and removing at least a portion of the first polymer from the ion exchange membrane coated fiber to form a tubular membrane coated fiber 915 (i.e., a tube shaped membrane with a fiber electrode extending through a lumen of the membrane). FIGS. 4A-B also illustrate portions of the method. As shown in FIGS. 4A-B, in some embodiments, the method can be a roll-to-roll manufacturing method.

As shown in FIG. 4A, the method can further comprise initially spinning the fiber electrode (such as a carbon fiber) from a spool prior to coating the fiber with first polymer.

The first polymer can be many different polymers known in the art. In some embodiments, the first polymer can be a water-soluble polymer, such as poly-vinyl alcohol (PVA). In some embodiments, the first polymer can be in a solution, while in some embodiments, the first polymer can be in a molten state.

In any of the embodiments disclosed herein, the first polymer can be water soluble, and removing at least a portion of the first polymer from the ion exchange membrane coated fiber can comprise exposing the ion exchange membrane coated fibers to a solvent, such as water, to dissolve at least a portion of the first polymer.

In any of the embodiments disclosed herein, removing at least a portion of the first polymer from the ion exchange membrane coated fiber can create an interstitial space in a lumen of the membrane coated hollow fiber. The size of the interstitial space can vary in accordance with various embodiments of the present disclosure.

The ion exchange membrane coated on the polymer coated fiber can be many different materials known in the art. In some embodiments, the ion exchange membrane can comprise a sulfonated tetrafluoroethylene-based fluoropolymer-copolymer, such as Nafion®. In some embodiments, the material forming the ion exchange membrane can be in a solution, and the solution can be coated onto the polymer coated fiber.

In some embodiments, the method can further comprise spinning the membrane coated hollow fiber onto a spool, where it can be later used to manufacture a battery.

In any of the embodiments disclosed herein, coating the fiber with at least a first polymer can comprise applying a dual layer coating to the fiber. The dual layer coating can comprise many different materials. In some embodiments, the dual layer coating can comprise an inner porous support layer and an outer ion-selective layer. Th inner porous support layer can comprise many different materials, including, but not limited to, glycol. The outer ion-selective layer can comprise many different materials, including, but not limited to, polyvinylidene fluoride (PVDF) layer.

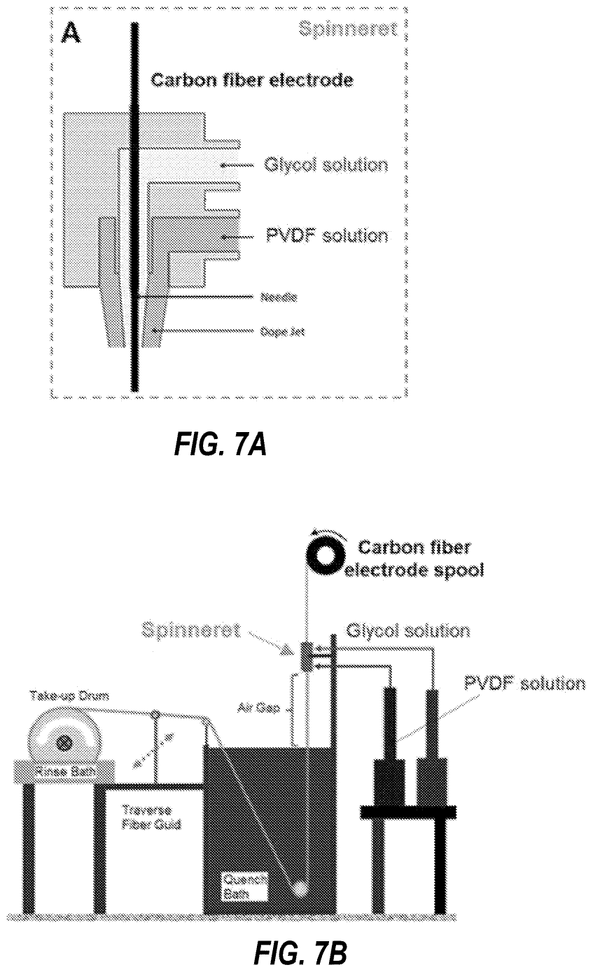

As shown in FIGS. 7A-B, in some embodiments, applying the dual layer coating to the fiber can comprise coextruding, using a triple orifice spinneret (FIG. 7A), the fiber, the inner porous support layer (e.g., glycol), and the outer ion-selective layer (e.g., PVDF). The spinneret can comprise an inner orifice for passing the fiber, an intermediate orifice for extruding the inner layer (e.g., glycol), and an outer orifice for extruding the outer layer (e.g., PVDF).

As shown in FIG. 7B, when the dual layer coated fiber exits the spinneret, it can be exposed to an air gap. The dual layer coated fiber can then be quenched in a water bath to phase invert the PVDF outer layer. The dual layer coated fiber can then be taken up by spinning on a drum before moving to the ion exchange membrane coating step, in which the outer layer (e.g., PVDF layer) can be coated with the ion exchange membrane (e.g., Nafion®). After being coated with the ion exchange membrane, in some embodiments, at least at least a portion of the inner layer (e.g., glycol) can be removed to create an interstitial space in the lumen.

### EXAMPLES

Below, certain examples of devices and methods of their manufacture are disclosed. The examples are for explanation purposes only and should not be construed as limiting the scope of the present disclosure.

A scalable hollow-fiber based co-axial microtubular flow battery was developed that significantly improves the volumetric power density by 5 to 10 times. Also, the cell eliminates the use of 2D flow channels and plates, and employs 1D tubular structure, which allows continuous wheel-to-wheel manufacturing (just as the co-axial electric cable) and facilitates the scale up. This universal design overcomes the power limit of planar cell configuration and is compatible with all mainstream redox chemistries such as vanadium, iron, zinc, bromine, and organic redox couples. Using zinc-iodine chemistry as a demonstration, the co-axial microtubular flow battery shows peak charge and discharge power densities of 814.1 W/Lcell and 220 W/Lcell compared to average charge and discharge power densities of <40 W/Lcell and 25 W/Lcell of conventional planar flow batteries.

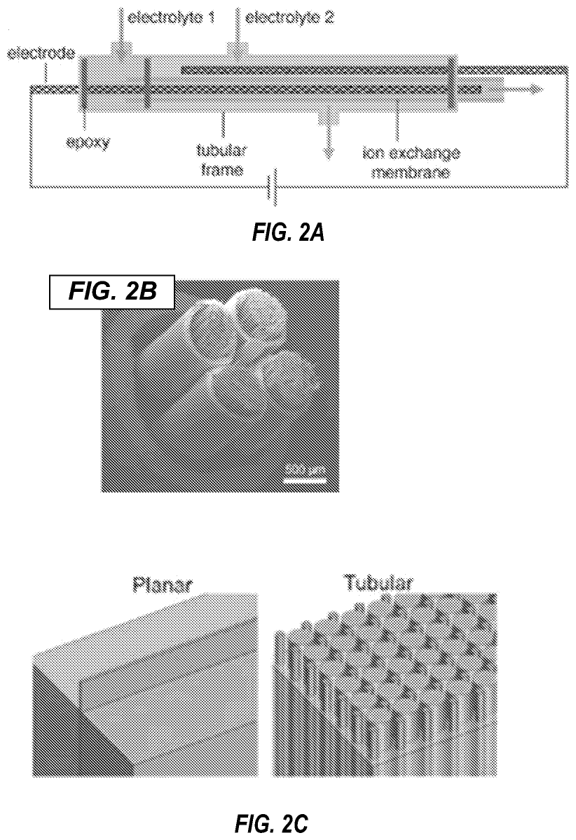

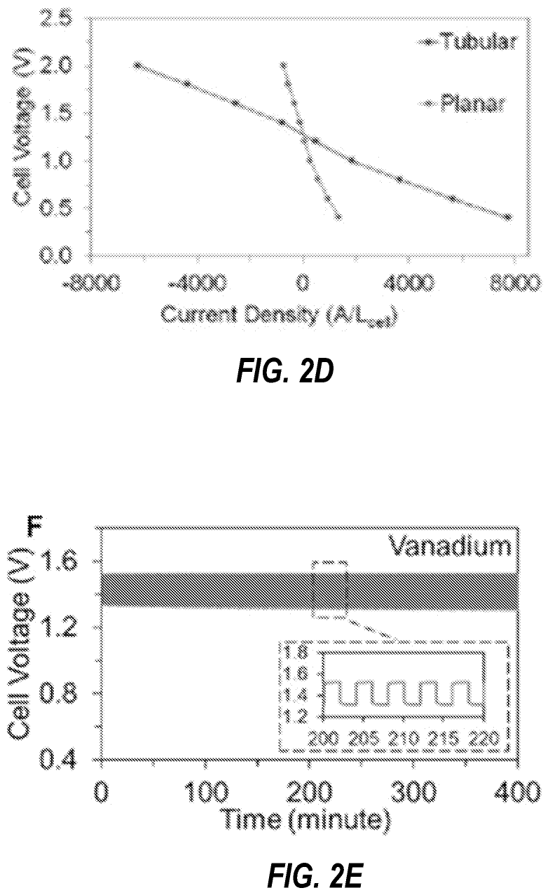

The co-axial microtubular (CAMT) flow cell is inspired by the hollow fiber membrane modules that are routinely used in chemical separation industry. As shown in FIG. 2A, the electrolytes pass through the device from bore and shell sides and are separated by tubular membranes while the electrodes extend out from the center. First, the membrane surface-area-to-volume ratio can be increased to match that of the electrode surface area, so the membrane no longer limits the ion transfer. Second, the hollow fiber itself can serve as the electrolyte distributor without any other supporting materials, avoiding extra distribution apparatus that decrease volumetric power density. Third, the system packing efficiency can be increased to have a smaller footprint at the same power level. A CAMT cell with four Nafion microtubes is shown In FIG. 2B. Each Nafion microtube is about 500 um in diameter, and is filled by carbon fiber, which acts as an electrode for the electrolyte flowing inside the microtubes. The fibrous counter electrode is placed outside the Nafion microtubes.

Although this disclosure focuses on an exemplary embodiment in which the flow battery is a vanadium redox battery, the disclosure here is not so limited and can be universally applied to many different chemistries.

Simulation of two cells with the same volume (FIG. 2C) shows that the CAMT cell has much lower overpotential (FIG. 2D), due to the larger membrane surface area in a given volume. Experimentally, in addition to the outstanding performances using zinc-iodine redox, good performance of vanadium redox was achieved in the CAMT cells (FIG. 2E).

The CAMT cells can have membrane surface area per volume. The high membrane surface area per volume in the CAMT cell configuration can enhance the volumetric power density of the cell, but can also increase the possibility for crossover. The ion-selective membrane (e.g. include a surface coating on the membrane or making a composite) can be engineered to slow down the crossover to a manageable level. Finally, the optimal length of the microtubular cell can be affected by the electron and mass transfer.

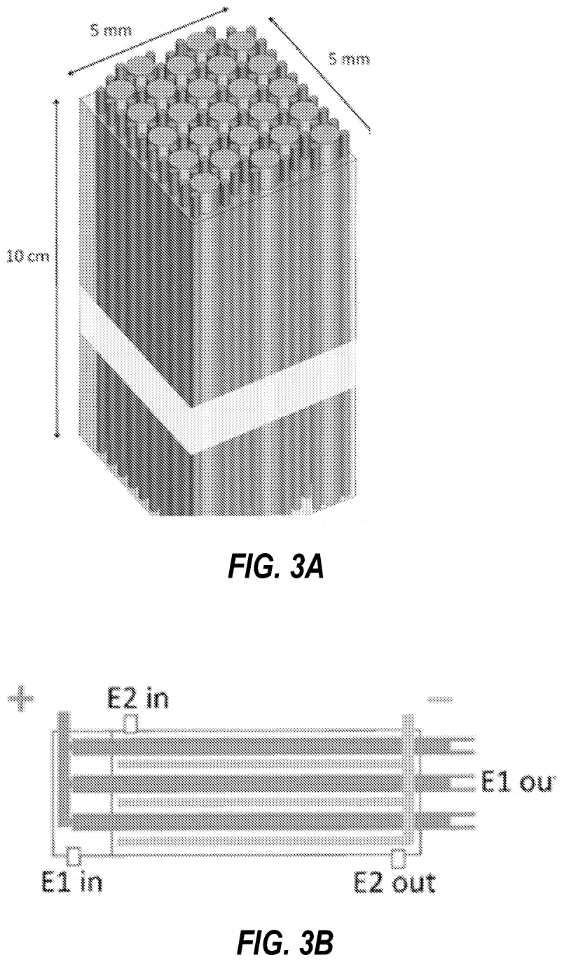

Inspired by the design of hollow fiber membranes module, co-axial microtubular (CAMT) flow battery cells of progressively increasing sizes can be created (FIGS. 3-4). In the co-axial microtubular CAMT cell, electrolytes pass through the device from bore and shell sides and can be separated by tubular membranes while the electrodes extend out from the center. First, the membrane surface-area-to-volume ratio can be increased to match that of the electrode surface area, so the membrane no longer limits the ion transfer. Second, the hollow fiber itself can serve as the electrolyte distributor without any other supporting materials, avoiding extra distribution apparatus that decrease volumetric power density. Third, the system packing efficiency can be increased to have a smaller footprint at the same power level. All the components used to fabricate the co-axial microtubular CAMT flow battery disclosed herein are commercially available, suggesting that the approach has potential for high scalability.

### Direct Manufacture of 1D Membrane-electrode Assembly:

The manual insertion of the fibrous electrodes into microtubes is not scalable. Accordingly, the present disclosure provides for scalable manufacturing of the Nafion/carbon composites, which are ready to be cut and directly assembled into modules. A roll-to-roll coating device can be used to fabricate composite fibers. A straightforward approach is to simply coat Nafion resin solution (commercially available) onto the carbon fibers. However, this can ultimately result in significant pressure drops of the electrolyte moving down the lumen side of the hollow fiber as the only flow path will be the interstitial space between the individual filaments within the carbon electrode (FIG. 4A).

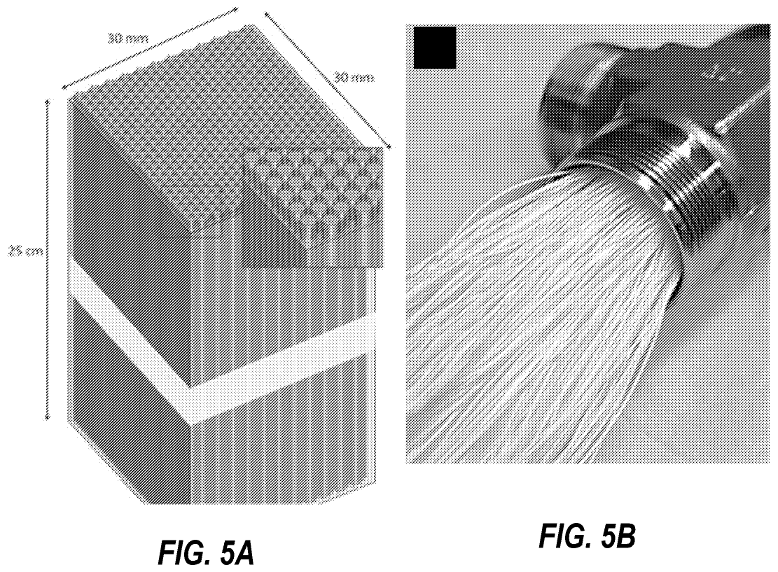

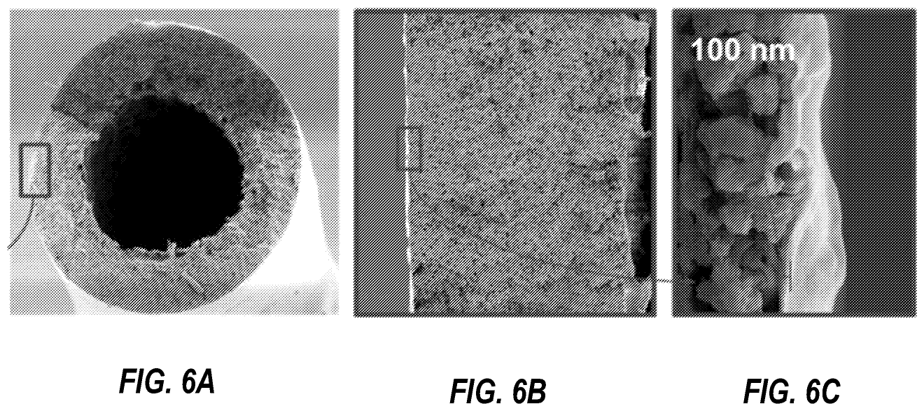

An approach disclosed herein is to first coat the carbon fiber electrodes with poly(vinyl alcohol) (PVA), a water soluble polymer that is compatible with Nafion. Once the PVA-coated fibers are collected on a spool, we will next coat the fibers with Nafion. The Nafion resin contains water and other solvents for PVA; however, the contact time in the coating solution can be sufficiently short (<1 second) that it is unlikely that the PVA will dissolve. Once the Nafion/PVA/Carbon fiber is created, the fibers can be soaked in water to dissolve the PVA and create larger interstitial spaces for electrolyte flow within the fiber lumen (FIG. 4B). These fibers can then be easily assembled into large scale modules. We have previously constructed modules that contain up to 1,300 fibers (FIG. 5B), which is sufficient for a 250 Wh demonstration. However, even larger modules can be built for a 12 kWh demonstration, or greater.

### Simulation of CAMT:

A physical model of the CAMT cell discussed above can be built using COMSOL Multiphysics, and its operation can be simulated. Briefly, tertiary current distribution module can be used to simulate the two electrodes. The equilibrium potentials at the electrodes can be calculated using Nernst equation and linked to the electric current using Butler-Volmer type of kinetics expressions. Nernst-Planck equations can be used for ion flux and charge transport in this model. The electrolyte current density can be calculated using Faraday's law by multiplying the contributions from the molar fluxes by the species charges. The conservation of charges can be used to calculate the electrolyte potential. The ion-exchange membrane can be simulated using a secondary current distribution module. The current passing the membrane can be determined by the potential gradient and the membrane conductivity. The boundary conditions at the boundaries between the membrane and the electrode domains can be set up based on Donnan conditions. The heat generation can be evaluated by adding up joule heating due to charge transport, electrochemical reactions, and heat of mixing. The pressure drop of electrolyte can be simulated according to Darcy's law and Brinkman equations by coupling fluid flow module.

The model can be calibrated with experimental results. After calibration, the model can be applied to simulate the performance of the 5 Wh CAMT module under more operating conditions to determine the trade-off between good energy storage capability and low operational energy consumption. In addition, the model can be used to study how the performance of the CMAT module is affected by some system parameters (e.g., the conductivity of the ion-exchange membrane) and other operating parameters (e.g., temperature). Additional experiments with the 5 Wh CAMT module can be conducted to validate the simulation results.

### Design and Scalable Manufacturing of 250 Wh Modules:

The model discussed above can be applied to guide the scale-up of the CAMT module from 5 Wh to 250 Wh. Models of CAMT modules with different configurations (e.g., the number of CAMT cells in a module, the length of the fibers, and the arrangement of the electrodes) can be built, and their performance can be simulated to achieve the desired operating power (i.e., 250 Wh). The optimal configuration for the 250 Wh CAMT module (e.g., 500 CAMT cells with length of 25 cm arranged like FIG. 5A) can then be selected with the lowest operational energy consumption according to the simulation results. As shown in FIG. 5B, modules can be fabricated with up to 1,300 fibers for filtration purpose.

Manual insertion of the electrodes can become infeasible as the module size increases. It can be estimated that the 250 Wh and 12 kWh modules will use totally 500 and 24,000 fibers, respectively. Electrode insertion can be performed by an automated system. Both the carbon electrode and Nafion hollow fiber can be cut to the designated length; a fast-drying glue loaded with magnetic nanoparticles (e.g., magnetite) can be applied to one end of the carbon electrode; the carbon electrode and hollow fiber can be aligned precisely with the magnetic head of the carbon electrode facing the opening center of the hollow fiber; a strong magnetic field can be applied to drive the carbon electrode through the hollow fiber.

### Dual-layer Microtubular Membrane for Lower Cost Than Bare Nafion:

Larger-scale CAMT systems can employ significant quantities of the Nafion-coated hollow fibers. Nafion is one of the most expensive components in flow battery systems. In order to reduce the usage of Nafion and thereby the cost of the system, a dual layer microtubular membrane can be used. At the same time, the number of processing steps associated with fabricating the Nafion/electrode composites can be reduced, which can be critical for scalability. PVDF has 1/10 of the price of Nafion and is chemically stable. Thus, PVDF/carbon fiber composites can be directly spun. To achieve this, a triple orifice spinneret that is routinely used to create multi-layer fiber structures can be utilized (FIG. 7A-B).

The carbon fiber electrode can be fed through a custom spinneret designed to coat metal wires. A liquid glycol feed and a PVDF polymer solution can be simultaneously co-extruded around the carbon fibers such that the glycol is in the interstitial spaces between the carbon fibers and the PVDF (FIG. 7A). The nascent fiber can be quenched into a water bath to phase invert the PVDF (i.e., create a porous substructure to provide mechanical support and low transport resistances) before being taken up on a rotating take-up drum (FIG. 7B). These fibers can then be wound onto spools and transferred to the roll-to-roll coating process described above to coat a thin Nafion layer onto the fiber supports. After fabrication, the glycol can be washed out of the supports by the electrolyte to create the freestanding Nafion/PVDF/carbon fibers with ample interstitial space for electrolyte flow.

### Produce Enough Cell Modules for Building a 12 kWh Electrode Stack:

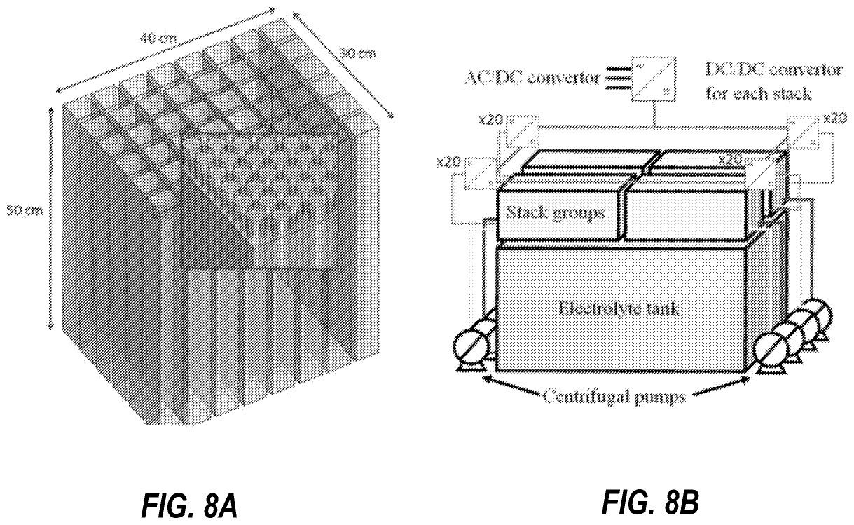

The manufacturing approaches discussed above can be combined to mass produce 48 of the 250 Wh modules and integrate a 12 kWh (2.4 kW) electrode stack (FIG. 8A). Serial electrical connection can be used. In this configuration, the expected system output voltage is around 50 V; the output current is around 48 A; the duration of discharge is around 5 hours. A parallel flow configuration can be used to ensure uniformity of electrolyte concentrations across modules.

### Integrate the Rest of the Components of the 12 kWh System:

The cell stack prepared above can be integrated with other components of a vanadium flow battery system (schematically shown in FIG. 8B).

### Quantify the Manufacturability, Power and Energy Density, Cycle and Calendar Life, Capital and Operation Cost of the System:

The performance and durability of the 12 kWh CAMT system discussed above can be tested under various operating conditions, similar to those discussed above. Again, the model can be calibrated with new experimental results and applied to optimize the operation of the 12 kWh CAMT system. COMSOL Multiphysics simulation can also be applied to help the assembly of the 12 kWh CAMT system with the 250 Wh CAMT modules. Both the electric current flow and the electrolyte flow of the CAMT modules can be connected either in parallel or in series, and these two types of flow can be arranged independently. For example, CAMT module A can be connected with CAMT module B in parallel for electric current flow but in series for electrolyte flow. Depending on how the CAMT system is assembled, each CAMT module can operate under different conditions (e.g., the flowrate and concentration of electrolytes). Therefore, different CAMT system designs can be simulated to determine the best configuration for the 12 kWh CAMT system.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A microtubular flow battery comprising:
tube-shaped ion exchange membranes each having an inner lumen 106 defined therewithin;
a first electrolytic fluid sufficing the inner lumens;
one or more first electrodes disposed within the inner lumens, the first electrodes being in contact with the first electrolytic fluid;
a second electrolytic fluid separated from the first electrolytic fluid by the tube-shaped ion exchange membranes; and
one or more second electrodes disposed among the tube-shaped ion exchange membranes outside of the inner lumens, the second electrodes being in contact with the second electrolytic fluid.

2. The microtubular flow battery of claim 1, wherein the first electrode comprises carbon fiber.

3. The microtubular flow battery of claim 1, wherein the microtubular flow battery is configured to provide a peak charge power density of at least 100 W/L_{cell}.

4. The microtubular flow battery of claim 1, wherein the microtubular flow battery is configured to provide a peak charge power density of at least 800 W/L_{cell}.

5. The microtubular flow battery of claim 1, wherein the microtubular flow battery is configured to provide a peak discharge power density of at least 30 W/L_{cell}.

6. The microtubular flow battery of claim 1, wherein the microtubular flow battery is configured to provide a peak discharge power density of at least 200 W/L_{cell}.

7. The microtubular flow battery of claim 1, wherein the one or more first electrodes have a surface-area-to-volume ratio that is within 50% of a surface-area-to-volume ratio of the tube-shaped ion exchange membranes.

8. The microtubular flow battery of claim 1, wherein the one or more first electrodes have a surface-area-to-volume ratio that is within 5% of a surface-area-to-volume ratio of the tube-shaped ion exchange membranes.

9.-10. (canceled)

11. The microtubular flow battery of claim 1, wherein:
the one or more first electrodes serve as cathodes of the microtubular flow battery: and
the one or more second electrodes serve as anodes of the microtubular flow battery.

12. The microtubular flow battery of claim 1 further comprising a chamber extending from a first end to a second end, the chamber having an interior chamber volume defined within an outer wall extending from the first end to the second end of the chamber, the interior chamber volume including:
a first interior chamber volume extending between a first end coincident with the first end of the chamber and a second end; and
a second interior chamber volume extending between a first end coincident with the second end of the first chamber volume and a second end coincident with the second end of the chamber;
wherein:
the microtubular flow battery is a co-axial microtubular flow battery;
the first and second electrolytic fluids are co-flowing electrolytic fluids separated within the second interior chamber volume by the tube-shaped ion exchange membranes;
the tube-shaped ion exchange membranes extend from a first end to a second end, the first end extending at least partially into the first interior chamber volume and the second end extending beyond the second end of the chamber;
the one or more first electrodes each extending between a first end and a second end, the first end of the first electrodes extending beyond the first end of the chamber and the second end of the first electrodes extending beyond the second end of the chamber;
the one or more second electrodes each extending between a first end and a second end, the first end of the second electrodes contained within the first interior chamber volume and the second end of the second electrodes extending beyond the second end of the chamber.

13. (canceled)

14. The microtubular flow battery of claim 12, wherein:
each of the first ends of the tube-shaped ion exchange members comprise an inlet positioned in the first interior chamber volume and configured to receive the first electrolytic fluid into the respective inner lumen; and
each of the second ends of the tube-shaped ion exchange members comprise an outlet for the first electrolytic fluid to exit out of the respective inner lumen.

15. The microtubular flow battery of claim 14, wherein:
each of the inlets of the tube-shaped ion exchange membranes are in fluid communication with a first electrolytic fluid supply source in fluid communication with the first interior chamber volume; and
the second interior chamber volume has a second electrolytic fluid inlet and is in fluid contact with a second electrolytic fluid supply source via the second electrolytic fluid inlet.

16. (canceled)

17. The microtubular flow battery of claim 1, wherein each of the one or more first electrodes are in electrical communication with each other.

18. The microtubular flow battery of claim 1, wherein each of one or more second electrodes are in electrical communication with each other.

19. The microtubular flow battery of claim 1, wherein the tube-shaped ion exchange membranes and one or more first electrodes are formed by:
coating the one or more first electrodes with at least a first polymer;
coating the polymer coated electrodes with ion exchange membrane material; and
removing at least a portion of the first polymer from the ion exchange membrane material coated electrodes to form the one or more first electrodes disposed within the inner lumens of the tube-shaped ion exchange membranes.

20.-21. (canceled)

22. The microtubular flow battery of claim 19, wherein the first polymer is a water-soluble polymer.

23. The microtubular flow battery of claim 19, wherein at least one of:
the first polymer is in a molten state;
the first polymer is in a solution;
the ion exchange membrane material is in a solution;
the first polymer comprises poly-vinyl alcohol (PVA); or
the ion exchange membrane material comprises a sulfonated tetrafluoroethylene-based fluoropolymer-copolymer.

24.-26. (canceled)

27. The microtubular flow battery of claim 23, wherein the sulfonated tetrafluoroethylene based fluoropolymer-copolymer is Nafion®.

28. (canceled)

29. The microtubular flow battery of claim 19, wherein;
the first polymer is water soluble; and
removing at least a portion of the first polymer from the ion exchange membrane material coated electrodes comprises exposing the ion exchange membrane material coated electrodes to water to dissolve the first polymer.

30.-31. (canceled)

32. The microtubular flow battery of claim 19, wherein coating the electrodes with at least a first polymer comprises applying a dual layer coating to the fiber electrodes, the dual layer coating comprising an inner porous support layer and an outer ion-selective layer.

33. The microtubular flow battery of claim 32, wherein applying the dual layer coating to the electrodes comprises coextruding, using a triple orifice spinneret, the electrodes, the inner porous support layer, and the outer ion-selective layer.

34. The microtubular flow battery of claim 32, wherein the tube-shaped ion exchange membranes and one or more first electrodes are further formed by quenching the polymer coated electrodes in a water bath to phase invert the outer ion-selective layer.

35.-36. (canceled)

37. The microtubular flow battery of claim 32, wherein the inner porous support layer comprises glycol.

38. The microtubular flow battery of claim 32, wherein the outer ion-selective layer comprises polyvinylidene fluoride (PVDF).

39. (canceled)

40. A co-axial microtubular flow battery comprising:
a chamber extending from a first end to a second end, the chamber having an interior chamber volume defined within an outer wall extending from the first end to the second end of the chamber, the interior chamber volume including:
a first interior chamber volume extending between a first end coincident with the first end of the chamber and a second end; and
a second interior chamber volume extending between a first end coincident with the second end of the first chamber volume and a second end coincident with the second end of the chamber;
tube-shaped ion exchange membranes each having an inner lumen defined therewithin, the tube-shaped ion exchange membranes each extending from a first end to a second end, the first end extending at least partially into the first interior chamber volume and the second end extending beyond the second end of the chamber;
co-flowing electrolytic fluids separated within the second interior chamber volume by the tube-shaped ion exchange membranes, the co-flowing electrolytic fluids comprising a first electrolytic fluid sufficing the inner lumens and a second electrolytic fluid separated from the first electrolytic fluid by the tube-shaped ion exchange membranes;
one or more first electrodes disposed within the inner lumens, the one or more first electrodes each extending between a first end and a second end, the first end of the first electrodes extending beyond the first end of the chamber and the second end of the first electrodes extending beyond the second end of the chamber;
one or more second electrodes disposed among tube-shaped ion exchange membranes outside of the inner lumens, the one or more second electrodes each extending between a first end and a second end, the first end of the second electrodes contained within the first interior chamber volume and the second end of the second electrodes extending beyond the second end of the chamber.

41. The co-axial microtubular flow battery of claim 40, wherein at least one of:
the co-axial microtubular flow battery is configured to provide a peak charge power density of at least 50 W/L_{cell};
the co-axial microtubular flow battery is configured to provide a peak charge power density of at least 800 W/L_{cell};
the co-axial microtubular flow battery is configured to provide a peak discharge power density of at least 30 W/L_{cell}, the co-axial microtubular flow battery is configured to provide a peak discharge power density of at least 200 W/L_{cell};
the one or more first electrodes have a surface-area-to-volume ratio that is within 50% of a surface-area-to-volume ratio of the tube-shaped ion exchange membranes; or
the one or more first electrodes have a surface-area-to-volume ratio that is within 5% of a surface-area-to-volume ratio of the tube-shaped ion exchange membranes.
